(19) United States
(12) Patent Application Publication
(10) Pub. No.: US 2008/0203304 A1
(43) Pub. Date: Aug. 28, 2008

(54) Multichannel instrumentation for large detector arrays

(75) Inventors: Lorenzo Fabris, Knoxville, TN (US); Norman W. Madden, Sparks, NV (US); Jeffrey W. Collins, Livermore, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(73) Assignee: The Regents of the University of CA

(21) Appl. No.: 11/710,227

(22) Filed: Feb. 22, 2007

(51) Int. Cl. G01J 1/00; G06F 19/00

(52) U.S. Cl. 250/336.1; 250/395; 702/57

(57) ABSTRACT

A multi-channel spectroscopy system that reads the radiation energy information deposited into a radiation detector, processes it and properly transfers it to a computer embedded to ancillary data (conditions, GPD information etc.). The implementation method chosen is a highly parallel structure of identical channels interfaced to the digital world through a custom-designed intelligent card (back-end) and a commercial data acquisition PC card.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates to radiation detection systems, and more specifically, it relates to instrumentation for such systems.

2. Description of Related Art

In the radiation detection community there is a need to instrument radiation detector systems made of one to several tens of thousands of detectors. The choice of technologies to instrument such systems is often obvious (although the actual implementation might not be): for a few channels, traditional discrete technologies are best suited, while for very large numbers (˜600 channels and up), Application Specific Integrated Circuits are often the best choice. However, in the region wherein the number of channels is between a few 10's and a few 100's, such a choice is often difficult.

Until now, there were only a limited number of commercial solutions. All prior solutions were also based on standard NIM, VME or VXI instrumentation modules, making the system unnecessarily bulky, expensive and power hungry. These additional burdens have made the deployment of such prior art solutions prohibitive.

### SUMMARY OF THE INVENTION

It is an object of the present invention to address the requirements for successfully and efficiently providing instrumentation for detector systems where the number of channels is between a few 10's and a few 100's.

This and other objects will be apparent based on the disclosure herein.

This invention is a full multi-channel spectroscopy system that reads the radiation energy information deposited into a radiation detector, processes it and properly transfers it to a computer embedded to ancillary data (conditions, GPD information etc.). The implementation method chosen is a highly parallel structure of identical channels interfaced to the digital world through a custom-designed intelligent card (back-end) and a commercial data acquisition PC card (National Instruments NI PCI-6534), so, the fundamental block is the single spectroscopy channel.

In an exemplary embodiment, a 64-channel data acquisition system (one channel for each scintillator-photomultiplier (PMT) detector) handles data from the system. The photomultiplier tubes (PMTs) are operated at a nominal gain of 105. The event generated charge from a PMT is converted into a voltage by a local capacitor connected directly to the anode at the PMT base. A voltage amplifier also connected to the PMT anode, sends the signal to the processing electronics. The system is built around a gated integrator with a parallel fast channel. A discriminator in the fast channel recognizes an event and initiates the signal processing cycle in the gated integrator. Voltage signals from a PMT are converted back into a short charge pulse and integrated for 2.2 μs. The integrated signal is then converted by a low-power, 16-bit ADC and decimated to an 11-bit word. This provides near nuclear quality conversion without the use of dithering. Every ADC generates an interrupt signal when it has valid data. The interrupt signals are decoded by a priority encoder and serviced by the steering logic. The ADC data is combined with the PMT number to form an event word. This is stored in a FIFO buffer. To allow a world-image map to be generated, the logic also generates periodic time stamp events and imager location events (the latter, through decoding of a fifth wheel attached to the vehicle.) These are also stored in the FIFO buffer. A fast PCI interface (NI-PCI-6534) is used to perform high-speed data transfer between the electronics and a personal computer. The system is designed to withstand a sustained rate of ˜100 kcps per channel. Total power consumption for the data acquisition system is ˜120 W. It is designed to run off of the vehicle power supply. Several tests have been performed and the system shows resolution performance dominated by the detector statistics.

The spectroscopy channel is built as a chain of preamplifier, signal shaper, analog to digital converter and I/O systems. The scintillator detectors respond to radiation by emitting light at a specific wavelength. The readout of this light is done through a PMT that converts light into electrical charge. The electrical charge is normally converted to voltage into a resistor, as the PMT acts as a noiseless current source. One embodiment uses a charge preamplifier as PMT readout device, because it provides further amplification of the generated charge, resulting in a less demanding operating point for the PMTs. This allows in practice to reduce the value of the high voltage bias applied to the PMT and the amount of charge extracted for every event. The benefit of this is in increased longevity of the PMTs, less demand on the components implementing the high voltage bias and low power bias strings. The charge integrated by the charge preamplifier is moved through a coaxial cable from the PMT to a custom analog signal processing board.

The signal processing board recognizes the presence of an event, processes it by optimizing the signal-to-noise ratio for the information, converts it into a 16-bit digital word and signals the back-end electronics that a digital representation of a radiation event is ready to be read out The readout of a given analog processing card is implemented by the back-end responding to a request. Every event read by the back-end is then organized in a digital word containing channel number and time stamp. A variety of ancillary information is also available to be embedded into the event word. The information could be a single bit or a 16-bit word coming from, for example, auxiliary analog to digital converters (also part of this development) or a velocity indicator. The back-end electronics sends the data to a personal computer through a commercial data acquisition card capable of communications up to 80 Mbytes/sec. Custom software is then used to interpret the data and do the appropriate analysis on it.

An embodiment of the invention provides instrumentation able to read out and process the signal from detector systems counting up to 128 channels of readout electronics. In principle, such a system can be used for the readout of up to 512 channels. The system targeted lanthanum-halide scintillating detector systems in its original implementation, but it is simple and flexible enough to allow the readout of other types of detectors such as gas-based radiation detectors. The system has been used in its 64-channel and 128-channel versions deployed respectively on a moving detection platform (truck) and on a particle accelerator.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a block diagram of the spectroscopy channel.

FIG. 2 is a simplified schematic of the gated integrator circuit

FIG. 3 is a system block diagram.

### DETAILED DESCRIPTION OF THE INVENTION

This invention is a full multi-channel spectroscopy system that reads the radiation energy information deposited into an array of radiation detectors, processes it and properly transfers it, embedded to ancillary data (temperature, inertial navigation, GPS information etc.), to a computer. The implementation method chosen is a highly parallel structure of identical channels interfaced to the digital world through a custom-designed intelligent card (back-end) and a commercial data acquisition PC card (National Instruments NI PCI-6534). The fundamental building block is the single spectroscopy channel designed around a gated integrator in each channel.

The spectroscopy channel is built as a chain of signal shaper, analog to digital converter and I/O system. Regardless of its nature, a radiation detector produces a signal that contains information proportional to the amount of charge deposited in the detector itself. Usually, this information is presented in the form of an electrical pulse with amplitude which is directly proportional to the radiation absorbed in the detector.

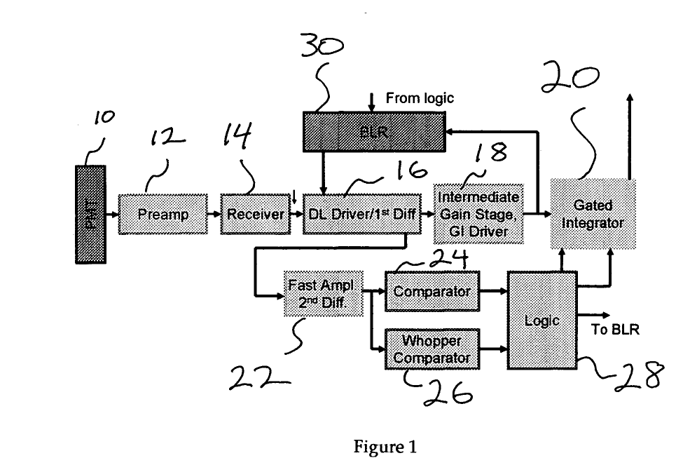

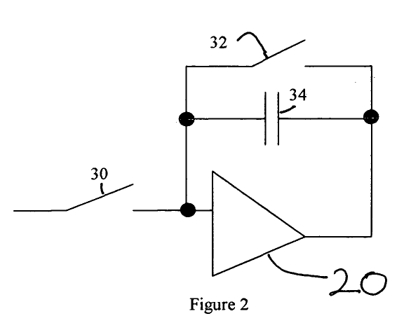

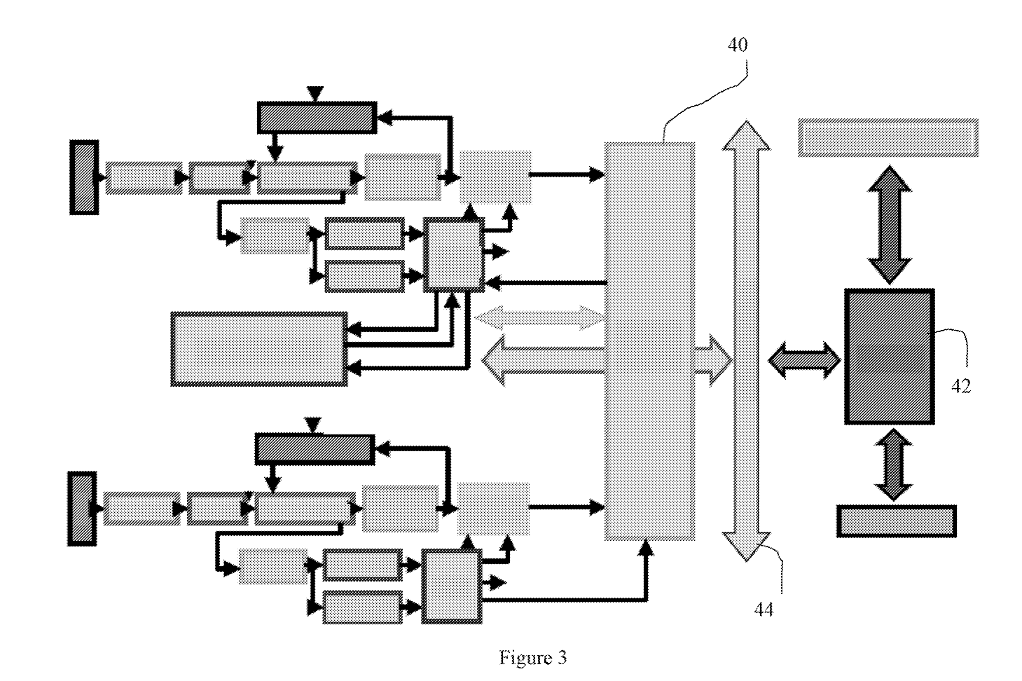

The spectroscopy channel has three main functions: recognizing the presence of an event from the detector, producing another electrical signal proportional to the energy absorbed (this signal differs from the signal mentioned above in that it has enhanced signal-to-noise ratio), and converting this signal into a digital number that can easily be read by a computer. An embodiment of the present spectroscopy channel is shown in FIG. 1 and includes the circuit blocks: Photo-multiplier tube 10, Preamplifier 12, Receiver 14, Delay Line Driver/1^{st} Differentiator 16, Intermediate Gain Stage, Gated Integrator Driver 18, Gated integrator 20, Fast Amplifier/2^{nd} Differentiator 22, Comparator 24, Whopper Comparator 26, Logic 28 and Base Line Restorer 30. FIG. 1 implements the required three main functions through the clever use of simple elementary blocks, chosen to minimize power consumption, board cost and complexity. The “recognition” function is done by a leading edge discriminator (blocks Fast Amplifier/2^{nd} Differentiator 22 and Comparator 24,). This circuit may be as simple as a few passive components and two active components, and yet it offers the possibility of providing good timing (to 100 ns) and detecting very low energies (down to 30 keV). The second function (producing a high signal-to-noise ratio signal proportional to the energy absorbed) is done by a Gated Integrator 20. When the signal is recognized by the fast channel, it is first delayed a few 100's ns and then presented at the input of the Gated Integrator 20. Referring to FIG. 2, which shows an exemplary circuit of Gated Integrator 20, has a switch 30 (normally open or OFF) at its input and another one 32 (normally closed or ON) in its feedback path, in parallel to a capacitor 34. The switches are switched ON and OFF respectively upon triggering of the fast channel, allowing the detector signal to be integrated on the capacitor 34. Once the appropriate time has elapsed (normally a multiple of the time response of the detector), the 12 quasi-nuclear quality analog-to-digital converter (40 in FIG. 3) is started and when the conversion is over, the switches are put back in their rest positions.

The use of the gated integrator circuit greatly simplifies the channel architecture and allows for lower power consumption by minimizing the number of active components required. Another benefit is that the gated integrator requires a smaller number of circuits in support of its operation. All settings (thresholds) for the analog channels are computer-controlled through the digital back-end.

Referring to the example system block diagram in FIG. 3, the converted signal is next sent to a digital back-end interface 42 through a low power fast GTLP bus 44 on a common motherboard, where all channels are plugged. The back-end digital interface accomplishes the tasks of (i) serving any channel that had a valid, converted event, (ii) combining the energy event with other relevant information, such as detector temperature information, actual position of the instrument in a map and instrument's heading and direction (46) into an “event word” and (iii) forwarding the event word to a computer 48 for processing.

The back-end accomplishes the above tasks at a speed such to accommodate high fluxes of data from the front-end circuits. Currently the maximum data transfer rate is set to 30 MByte/s and is accomplished through a commercial PCI data acquisition card installed in the computer.

The back-end design follows the same approach used for the other parts of the system: low power, low component counts, but also adds the desirable feature of being a very flexible system: its input and functionality can be modified to accommodate for many needs. For example, the back-end can accept digital information from an inertial navigation unit, a GPS unit or any other kind of off-the-shelf component that can communicate over RS-232. Also, the back-end can accept analog information (converted in digital format into a daughter card), such as environmental information. Finally, this circuit can accept straight binary conditions such as “veto” or “gating” information in a set of dedicated digital inputs.

The data acquisition system is complemented by a high voltage generation circuit that provides power to the radiation detectors. The high voltage outputs are individually computer controlled through the back-end. The freedom of controlling all system settings (high voltage outputs, thresholds in the analog channels) allows the user to implement automated calibration routines and offers full flexibility in setting parameters for the system.

A digital computer system can be programmed to perform aspects of the method of this invention. Once programmed to perform particular functions pursuant to instructions from program software that implements the method of this invention, such digital computer system in effect becomes a special-purpose computer particular to the method of this invention. The techniques necessary for this are well-known to those skilled in the art of computer systems.

Computer programs implementing aspects of the method of this invention will commonly be distributed to users on a distribution medium such as floppy disk or CD-ROM. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The term “computer-readable medium” encompasses distribution media, intermediate storage media, execution memory of a computer, and any other medium or device capable of storing for later reading by a computer a computer program implementing the method of this invention.

### REFERENCES

1. Maximum detector sizes required for orphan source detection, K. P. Ziock, K. E. Nelson, Submitted to NIM A, 2006. This reference is incorporated herein by reference.

2. The Lost Source, Varying Backgrounds and Why Bigger May not be Better, K. P. Ziock, W. H. Goldstein, in “Unattended Radiation Sensor Systems for Remote Applications”, J. Trombka, D. Spears, P. Solomon ed., AIP Conf. Proc. 632, (American Institute of Physics, Melville, N.Y., 2002) 60-70. This reference is incorporated herein by reference.

3. Coded aperture imaging with uniformly redundant arrays, E. E. Fenimore and T. M. Cannon,” Appl. Opt, 17, no. 3, pp. 337-347, February 1978. This reference is incorporated herein by reference.

4. Large Area Imaging Detector for Long-Range, Passive Detection of Fissile Material, K. P. Ziock, W. C. Craig, L. Fabris, R. C. Lanza, S. Gallagher, B. K. P. Horn, N. W. Madden, IEEE Trans. Nuclear Science 51, 2238-2244, 2004. This reference is incorporated herein by reference.

5. Source-Search Sensitivity of a Large-Area, Coded-Aperture, Gamma-Ray Imager, K. P. Ziock, W. W. Craig, L. Fabris, R. C. Lanza, S. Gallagher, B. K. P. Horn, N. W. Madden, E. Smith, M. Woodring, Proceedings IEEE Nuclear Science Symposium and Medical Imaging Conference, Rome, Italy, Oct. 18-23, 2005. (to appear in IEEE Trans. Nucl. Sci.) This reference is incorporated herein by reference.

6. Scintillation Imaging: A Technique to Reduce Coding Noise in Scanned, Coded-Aperture Imagers, K. P. Ziock, SPIE Conf. 5540, 225-234, 2004. This reference is incorporated herein by reference.

7. Co-pending U.S. patent application Ser. No. ______, titled: “Dual-Sided Coded-Aperture Imager”, by Klaus-Peter Ziock, filed Feb. 22, 2007, incorporated herein by reference.

The foregoing references, and all documents cited therein, and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A plurality of spectroscopy channels, each channel comprising:
means for recognizing the presence of an event from a detector, wherein said event comprises energy absorbed by said detector;
means for producing an electrical signal proportional to said energy absorbed by said detector; and
means for converting said electrical signal into a digital number that can be read by a computer.

2. The channels of claim 1, wherein said means for recognizing the presence of an event comprises a leading edge discriminator.

3. The channels of claim 2, wherein said leading edge discriminator comprises a fast amplifier/differentiator and a comparator.

4. The channels of claim 1, wherein said means for producing an electrical signal proportional to said energy absorbed by said detector comprises a gated integrator.

5. The channels of claim 4, wherein said gated integrator comprises a first switch that is normally open at its input and wherein said gated integrator comprises a second switch that is normally closed in a feedback path of said integrator, wherein said gated integrator comprises a capacitor in parallel with said second switch, wherein said gated integrator is configured such that upon triggering, said first switch is switched closed and said second switch is switched opened, wherein said energy absorbed by said detector will integrated on said capacitor to produce an integrated signal.

6. The channels of claim 1, wherein said means for converting said electrical signal into a digital number that can be read by a computer comprises an analog-to-digital converter that produces a converted signal from said electrical signal, a bus; and a digital back-end interface, wherein said bus transfers said converted signal to said interface.

7. The channels of claim 6, wherein said quasi-nuclear quality analog-to-digital converter comprises a 12 quasi-nuclear quality analog-to-digital converter.

8. The channels of claim 6, wherein said bus comprises a low power fast GTLP bus.

9. The channels of claim 6, wherein said digital back-end interface is configured to serve any channel that had a valid, converted event

10. The channels of claim 6, wherein said digital back-end interface is configured to combine said event with other information and form a digital event word, wherein said digital back-end interface is configured to forward said event word to a computer for processing.

11. A method for converting an electrical signal into a digital number that can be read by a computer, comprising:
recognizing the presence of an event within a detector channel of a plurality of detector channel, wherein each detector channel comprises a single detector, wherein said event comprises energy absorbed by said detector;
producing an electrical signal proportional to said energy absorbed by said detector; and
converting said electrical signal into a digital number that can be read by a computer.

12. The method of claim 11, wherein the presence of said event is recognized by a leading edge discriminator.

13. The method of claim 12, wherein said leading edge discriminator comprises a fast amplifier/differentiator and a comparator.

14. The method of claim 11, wherein a gated integrator produces said electrical signal such that it is proportional to said energy absorbed by said detector.

15. The method of claim 14, wherein said gated integrator comprises a first switch that is normally open at its input and wherein said gated integrator comprises a second switch that is normally closed in a feedback path of said integrator, wherein said gated integrator comprises a capacitor in parallel with said second switch, wherein said gated integrator is configured such that upon triggering, said first switch is switched closed and said second switch is switched opened, wherein said energy absorbed by said detector will integrated on said capacitor to produce an integrated signal.

16. The method of claim 11, wherein an analog-to-digital converter produces a converted signal by converting said electrical signal into said digital number that can be read by said computer, said method further comprising transfering said converted signal to a digital back-end interface over a bus.

17. The method of claim 16, wherein said analog-to-digital converter comprises a 12 quasi-nuclear quality analog-to-digital converter.

18. The method of claim 16, wherein said bus comprises a low power fast GTLP bus.

19. The method of claim 16, wherein said digital back-end interface is configured to serve any channel that had a valid, converted event.

20. The method of claim 16, wherein said digital back-end interface is configured to combine said event with other information and form a digital event word, wherein said digital back-end interface is configured to forward said event word to a computer for processing, said method further comprising forming a digital word by combining said event with said other information and transferring said digital word to said computer.
